(19) United States
(12) Patent Application Publication
(10) Pub. No.: US 2015/0100164 A1
(43) Pub. Date: Apr. 9, 2015

(54) SYSTEMS AND METHODS FOR MONITORING AND/OR CONTROLLING RESOURCES OF BUILDING STRUCTURES VIA A DASHBOARD INTERFACE

(71) Applicant: InScope Energy, LLC, Reston, VA (US)

(72) Inventors: Jason Bruce Craig, Middleburg, VA (US); Richard Daniel Albarran, Bethesda, MD (US); William Clayton Pugh, Haymarket, VA (US); Scott Dewey Blair, JR., Reston, VA (US)

(73) Assignee: InScope Energy, LLC, Reston, VA (US)

(21) Appl. No.: 14/046,841

(22) Filed: Oct. 4, 2013

(51) Int. Cl. G05B 15/02

(52) U.S. Cl. CPC G05B 15/02
USPC 700/276; 700/275

(57) ABSTRACT

Resources including electricity, water, gas, and/or other resources of building structures may be monitored and/or controlled by an administrator via a dashboard interface. A usage field presented via the dashboard interface may convey information associated with usage of a resource of a structure. The information conveyed by the usage field may be determined based on a selected breakdown, which may include one or more of a breakdown of resource usage by panel, by location, by usage type, by security level, and/or by other breakdowns. The information conveyed by the usage field may be determined based on a selected region, which may include one or more of a group of structures, portions of structures in a group, a single structure, a portion of a structure, a floor of a structure, a room of a structure, a hallway of a structure, a stairwell of a structure, and/or other spatial region.

### FIELD OF THE DISCLOSURE

This disclosure relates to systems and methods for monitoring and/or controlling resources of building structures including electricity, water, gas, and/or other resources via a dashboard interface.

### SUMMARY

One aspect of the disclosure relates to a system configured for monitoring and/or controlling resources of building structures, in accordance with one or more implementations. Resources including electricity, water, gas, and/or other resources of building structures may be monitored and/or controlled by an administrator via a dashboard interface. Exemplary implementations may facilitate maintaining visibility, identifying and prioritizing opportunities for conservation of resources, optimizing resource consumption, prognostics, operations and maintenance, managing costs, and/or other purposes.

A usage field presented via the dashboard interface may convey information associated with usage of a resource of a structure. The information conveyed by the usage field may be determined based on a selected breakdown, which may include one or more of a breakdown of resource usage by electric distribution panel, by location, by usage type, by purpose, by occupied tenant, by security level, by a customized breakdown, and/or by other breakdowns. The information conveyed by the usage field may be determined based on a selected region, which may include one or more of a group of structures, portions of structures in a group, a single structure, a portion of a structure, a floor of a structure, a room of a structure, a hallway of a structure, a stairwell of a structure, and/or other spatial region.

The system may include a plurality of sensors and/or other components. Different ones of the sensors may be configured to provide signals conveying information associated with various resource usages and/or various ambient conditions. In some implementations, the system may include one or more servers. The server(s) may be configured to communicate with one or more client computing platforms according to a multi-tier client/server architecture. The users (e.g., an administrator) may access the system via the client computing platform(s). The server(s) may be configured to execute one or more computer program modules. The computer program modules may include one or more of a resource metric module, an ambient parameter module, a dashboard interface module, a usage module, a region selection module, a breakdown selection module, a policy module, and/or other modules.

The resource metric module may be configured to determine one or more resource metrics associated with usage of one or more resources of one or more structures. A given resource metric may be based on information received from one or more sensors. A given resource metric may include a rate of usage, an amount used during a specified period of time, an average usage amount and/or rate, system faults, a minimum and/or maximum usage during a specified period of time, current rate or flow, and/or other metrics associated with resource usage.

The ambient parameter module may be configured to determine one or more ambient metrics associated with ambient conditions inside or outside of the one or more structures. A given ambient parameter may be based on information received from one or more sensors. The ambient conditions inside the one or more structures may include a temperature inside the one or more structures, a humidity inside the one or more structures, air quality inside one or more structures, thermostat settings inside one or more structures, an air flow inside the one or more structures, and/or other ambient conditions inside the one or more structures. The ambient conditions outside the one or more structures may include a temperature outside the one or more structures but nearby, a humidity outside the one or more structures but nearby, an air flow outside the one or more structures but nearby, and/or other ambient conditions outside the one or more structures.

The dashboard interface module may be configured to provide a dashboard interface for presentation to an administrator. The dashboard interface may be configured to facilitate interactions between the system and the administrator. The interactions may include providing information to and receiving information from the administrator. The dashboard interface may include a graphical user interface. The dashboard interface may include various text, graphics, plots, and/or other visual features to convey information to a user.

The usage module may be configured to provide a usage field for presentation via the dashboard interface. The usage field may convey information associated with usage of one or more resources of one or more structures. The information associated with the usage may include a usage plot showing a usage metric as a function of time. In some implementations, the information associated with the usage may include a usage plot showing a usage metric and an ambient metric both as a function of time. The ambient metric may be associated with ambient conditions inside or outside of the one or more structures. The usage plot may include a histogram of energy used per day as a function of time. The usage plot may be associated with a selectable time range. The usage plot may include an expected usage range as a function of time. The usage plot may convey a set point as a function of time. The set point may be the temperature setting of an HVAC system within the one or more structures. The usage plot may convey a comparison between two or more regions of the one or more structures.

The usage plot may include an indication of occupancy as a function of time. The indication of occupancy may include a binary indication (e.g., occupied or unoccupied), an indication of a portion of total capacity (e.g., 75% occupied), an indication of absolute occupancy (e.g., five occupants), and/or other indications of occupancy. The usage plot may convey one or both of check in times or check out times. A given check in time may be a time at which a structure occupant checked into or is scheduled to check into the one or more structures. A given check out time may be a time at which a structure occupant checked out of or is scheduled to check out of the one or more structures.

The region selection module may be configured to provide a region selection field for presentation via the dashboard interface. The region selection field may be configured to receive a region selection from the administrator. The region selection may indicate one or more spatial regions of one or more structures. A given region may include one or more of a group of structures, portions of structures in a group, a single structure, a portion of a structure (e.g., the west wing), a floor of a structure, a room of a structure, a hallway of a structure, a stairwell of a structure, and/or other spatial regions of one or more structures. The information conveyed by the usage field may be determined based on a given region responsive to the given region being a selected region.

The breakdown selection module may be configured to provide a breakdown selection field for presentation via the dashboard interface. The breakdown selection field may be configured to receive a breakdown selection from the administrator. The breakdown selection may indicate one or more breakdowns of resource usage within the selected region. A given breakdown may include one or more of a breakdown of resource usage by electric distribution panel, a breakdown of resource usage by location, a breakdown of resource usage by usage type, a breakdown of resource usage by usage purpose, a breakdown of resource usage by occupied tenant, a breakdown of resource usage by security level, a breakdown of resource usage by a customized breakdown, and/or other breakdowns of resource usage. The information conveyed by the usage field may be determined based on a given breakdown responsive to the given breakdown being a selected breakdown.

The policy module may be configured to facilitate creation and/or enforcement of policies associated with usage of one or more resources of one or more structures. A given policy may specify how a given resource should be used for one or more breakdowns. For example, one policy may specify whether lights should be on or off, or be dimmed (1) during a specified period of time (2) for a specified region of one or more structures. As another example, one policy may specify heating or cooling parameters for a given tenant. Creating a given policy may include specifying one or more resources, and how those resources should be used for one or more breakdowns. Enforcing a given policy may include effectuating requirements set forth by that policy.

The policies may be tiered such that some policies encompass sub-policies. For example, a first policy may be associated with one or both of a first spatial region of the one or more structures or a first breakdown of resource usage, while a second policy may be associated with one or both of a subset of the first spatial region or a subset of the first breakdown. By way of non-limiting illustration, the first policy may be associated with an entire building whereas the second policy may be associated with a single floor within that building. In some implementations, the usage field may convey information associated one or more policies.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for monitoring and/or controlling resources of building structures, in accordance with one or more implementations.

FIG. 2 illustrates an exemplary dashboard interface configured to facilitate interactions between the system of FIG. 1 and an administrator, in accordance with one or more implementations.

FIGS. 3A-3E show screen shots of exemplary implementations of a dashboard interface.

FIG. 4 illustrates a method for monitoring and/or controlling resources of building structures, in accordance with one or more implementations.

### DETAILED DESCRIPTION

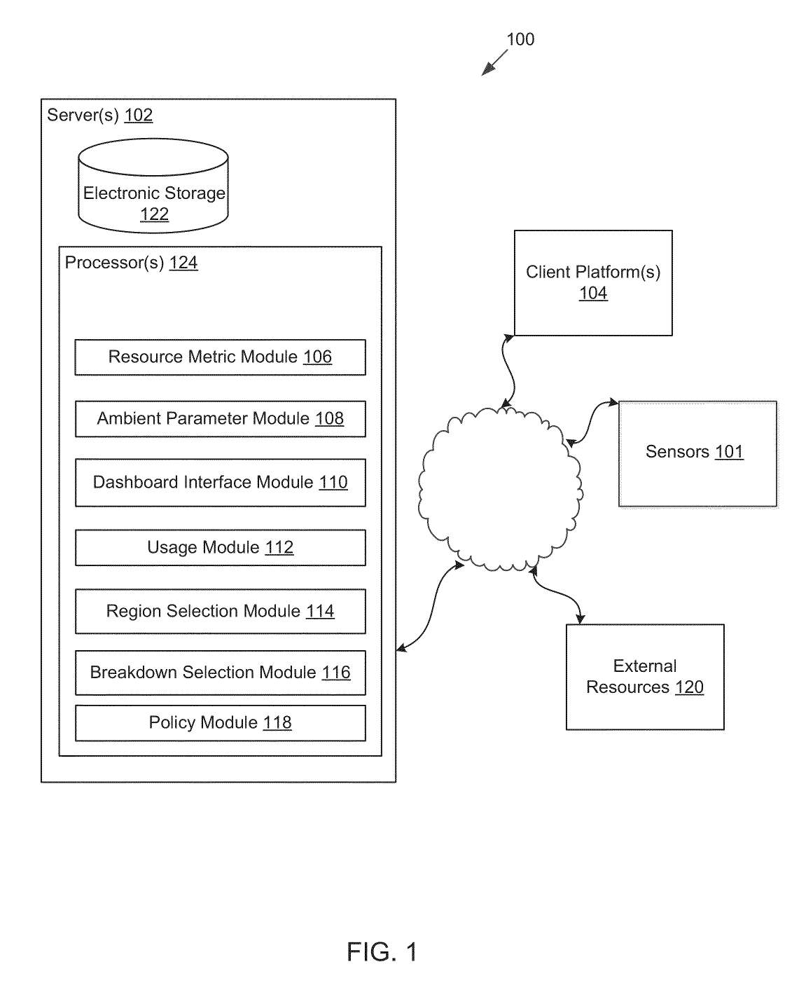

FIG. 1 illustrates a system 100 configured for monitoring and/or controlling resources of building structures, in accordance with one or more implementations. Resources including electricity, water, gas, and/or other resources of building structures may be monitored and/or controlled by an administrator via a dashboard interface. Exemplary implementations may facilitate maintaining visibility, identifying and prioritizing opportunities for conservation of resources, optimizing resource consumption, prognostics, operations and maintenance, managing costs, and/or other purposes. While exemplary implementations are described in the context of building structures such as office buildings and houses, this is not intended to be limiting. For example one or more implementations may be applied to vehicle (e.g., a car or a truck), a vessel (e.g., a boat or ship), other inhabitable structures (e.g., temporary structures), a building complex, and/or other physical systems.

The system 100 may include sensors 101. Different ones of the sensors 101 may be configured to provide signals conveying information associated with various resource usages and/or various ambient conditions. For resource usage, sensors 101 may include one or more of a power sensor, a voltage sensor, an electrical current sensor, other sensors associated with electricity usage, water flow sensors, other sensors associated with water usage, gas flow sensors, other sensors associated with gas usage, and/or other sensors associated with measuring resource usage. For electrical energy, one or more sensors 101 may be installed within a building structure such as at a structure distribution panel, outlet, fixture, and/or at other locations. For ambient conditions, sensors 101 may include one or more of a thermometer, a sensor for measuring temperature, a humidity sensor, an air flow sensor, an occupancy sensor, a motion sensor, a heat sensor, a light sensor, a pressure sensor, a sound sensor, a vibration sensor, and/or other sensors associated with measuring ambient conditions. A given sensor 101 may be configured to sample at regular intervals, at specific times of day, on specific days, and/or at other times or according to other schedules. Signals from individual ones of sensors 101 may be transmitted to other components of system 100. The signals may be transmitted wirelessly, by wire, and/or by other means.

Various analyses may be performed based on usage data from individual sensors 101 and/or groups of sensors 101. Energy (or other resource) usage trending and behavior analysis may be based on statistical mean and standard deviation calculations of historical baseline data for individual sensors 101 and/or groups of sensors 101. Requirements for a valid baseline may be determined based on types of sensors 101, particular resource(s) being measured, and/or other information.

Individual sensors 101 may be classified based on type, susceptibility to influence on usage by external variables, and/or other information. By way of non-limiting example, an external variable may include weather, fluctuations of which may drastically affect energy consumption for some buildings. Other examples of external variables may include one or more of highly-variable occupancy (e.g., hotels), time of day (e.g., a 9-to-5 office vs. 24-hour facility), day of week (e.g., Monday vs. Sunday), seasonal use (e.g., for a high school), non-deterministic/highly volatile (e.g., for a microwave).

Usage associated with a given sensor 101 may be classified as weather dependent or weather independent, as appropriate along with its projected degree of correlation. An example of a weather independent sensor 101 may be a branch of an electrical panel that feeds a kitchen refrigerator. Baseline usage for such a sensor 101 may be directly related to building occupancy schedules, day of week, and time of day. A weather dependent device, such as a branch of an electric panel that supplies energy to a building air conditioner unit, may require historical data from days with comparable external temperature and weather conditions in addition to the weather independent device baseline variables. Weather observation and forecast data for the surrounding area may be correlated with usage information obtained via sensors 101 for weather dependent devices to derive normalization algorithms used to reduce the effect of weather fluctuations on behavioral analyses, historical trends, cost calculations, alarm/warning indicators provided by the system, and/or other information associated with system 100. The system 100 may perform periodic assessments to automatically identify devices with a strong correlation to weather and adjust classifications, according to some implementations.

In some implementations, information associated with occupancy may be applied to a process similar to weather normalization to derive accurate cost calculation functions by removing the occupancy variable where appropriate. Light sensors may be integrated with the control function of the system to manage artificial lighting needs throughout a building more efficiently where ambient natural light would otherwise be sufficient.

Ongoing resource usage information may be compared with established trends and/or user defined thresholds to provide comprehensive visibility over building assets in real or near-real time. Notification and alarm policies may be configured for a structure or group of structures (e.g., a campus). Resource usage information may be analyzed for compliance with any applicable policies and notifications may be sent to interested parties. Examples of policies may include loss of power, loss of communications, loss of phase, exceeding of defined thresholds for temperature, tariffs, water usage, wattage, voltage, current, weighted score/rank, power factor in real-time or as a daily total, and/or other policies. Alarm conditions may be acknowledged by authorized users for auditing and accountability. Situations where an event occurs but is not addressed by an existing policy may be tagged on an individual basis. Identified events may be factored into behavioral analyses where appropriate.

Visibility may be provided by system 100 by way of a comprehensive suite of dashboards and/or reporting features. Resource usage locations of interest may be positively identified by system 100 by correlating a magnitude of deviation from normalized historical mean with the difference from observed usage. This may ensure that devices and/or other electrical loads with lower average usage, for which even a small amount of change can otherwise qualify as a large percentage of the total, are properly weighed against devices with larger usage totals. Likewise, devices with lower overall usage may not be required (or desired) to be as highly visible where focus is cost savings and energy conservation. The system 100 may be configured to apply different weights to these factors for locations as needed.

Utility billing records may be imported into system 100 to provide a basis for monetary calculation as it relates to equivalent cost per unit of energy. This may be used by various components of system 100 to provide an approximation of costs as an alternative unit in reports as well as a component of ROI (i.e., return on investment) predictive models. By combining recent usage with historical baselines and price per unit estimates, forecasts may be made for the future including anticipated usage and costs. The system 100 may be notified of expected event occurrences and forecast models may be adjusted accordingly (e.g., replacing lights with lower energy variants). By comparing a forecast with actual or hypothetical investment costs, an ROI model may be derived. Due to the highly complex and volatile billing schedules employed by may utility companies, ongoing maintenance of monthly billing data in system 100 may be critical for the accuracy of reported price estimates, in some implementations.

Control of electrical loads may be implemented where usage is either deterministic, risk exposure is high, and/or in emergency situations. This may be accomplished in a number of ways depending on the specific sensor 101 used, existing monitoring/control subsystems, and/or established security policies. The base control capability may be provided by a given sensor 101 in the form of switching and control. This feature may be managed securely by an authorized system user by configuring and assigning a control schedule or on-demand for individual sensors 101 and/or groups of sensors 101. Control commands may be sent to a managing controller for individual sensors 101 and/or groups of sensors 101. This feature may be configured with additional security through a local approval mechanism where needed.

Forecast models may be used by application business intelligence and background analytics to provide suggestions to interested parties of opportunities to reduce costs and waste as well as optimize standard processes by adjusting control schedules if desired. A common challenge for many buildings involves careful execution of spin-up procedures each morning to get internal temperatures comfortable for occupants before they arrive without exceeding peak thresholds or wasting resources. Information associated with resource usage may be analyzed to determine the optimal order and time of execution for these processes from observed occupancy trends. Control scheduling, manual overrides, and/or alarm monitoring capabilities may be employed by system 100 to execute building spin-up at the appropriate time each day, factoring in weather forecast data to determine the correct time to execute and avoiding tariff thresholds by load shedding if necessary.

For example, many buildings are subject to varying rate schedules imposed by their local utility providers for which pricing is partially dependent upon peak consumption during business hours. Even a single instance of exceeding one of these thresholds can result in the per unit energy cost increasing to a higher rate schedule for the duration of the billing cycle. In some contracts, it can impact costs for the next 12 months. Consequently, careful attention must be paid by building managers to energy utilization during these times. A key contributor to peak energy usage is the activation of most of building resources within a comparatively short timeframe prior to start of business. Heating and cooling, lighting, air flow, water and appliances may be spun-up in a particular order and/or at staggered intervals in order to manage resources efficiently. Any miscalculation or error in this procedure each morning could result in peak thresholds being exceeded.

The control functions of system 100 may be employed in collaboration with robust monitoring and notification capabilities to help manage daily spin-up procedures and respond in the event of anomalies by shutting down lower priority resources. Thresholds may be established within the system that will notify stakeholders at defined levels and/or enact control policies prior to peak levels being exceeded if desired. The system 100 may respond to potentially problematic usage trends by disabling low priority, malfunctioning, unnecessary, and/or other identified resources in real or near-real time.

Proactive adjustments to daily spin-up procedures may be made automatically by factoring in weather forecast and/or historical trending data available to system 100. By way of non-limiting example, recognizing that tomorrow will be unseasonably warm and that the building historically requires an additional 20 minutes to reach habitable internal temperatures in similar weather, building managers may be notified and any applicable control schedules may be rearranged as needed. Combined with ongoing analysis, regular adjustments to building control schedules based on season, day of week, and identified events, resource usage can be effectively managed. Some implementations may include components and/or functionalities that are the same as and/or similar to those described in U.S. Pat. No. 8,437,882 filed Feb. 17, 2010 and entitled “MANAGING POWER UTILIZED WITHIN A LOCAL POWER NETWORK,” which is incorporated herein by reference.

In some implementations, system 100 may include one or more servers 102. The server(s) 102 may be configured to communicate with one or more client computing platforms 104 according to a multi-tier client/server architecture. The users (e.g., an administrator) may access system 100 via client computing platform(s) 104. The server(s) 100 may be configured to execute one or more computer program modules. The computer program modules may include one or more of a resource metric module 106, an ambient parameter module 108, a dashboard interface module 110, a usage module 112, a region selection module 114, a breakdown selection module 116, a policy module 118, and/or other modules.

The resource metric module 106 may be configured to determine one or more resource metrics associated with usage of one or more resources of one or more structures. A given resource metric may be based on information received from one or more sensors 101. A given resource metric may include a rate of usage, an amount used during a specified period of time, an average usage amount and/or rate, system faults, a minimum and/or maximum usage during a specified period of time, current rate or flow, and/or other metrics associated with resource usage.

The ambient parameter module 108 may be configured to determine one or more ambient metrics associated with ambient conditions inside or outside of the one or more structures. A given ambient parameter may be based on information received from one or more sensors 101. The ambient conditions inside the one or more structures may include a temperature inside the one or more structures, a humidity inside the one or more structures, an air flow inside the one or more structures, and/or other ambient conditions inside the one or more structures. The ambient conditions outside the one or more structures may include a temperature outside the one or more structures but nearby, a humidity outside the one or more structures but nearby, air quality inside one or more structures, thermostat settings inside one or more structures, an air flow outside the one or more structures but nearby, and/or other ambient conditions outside the one or more structures.

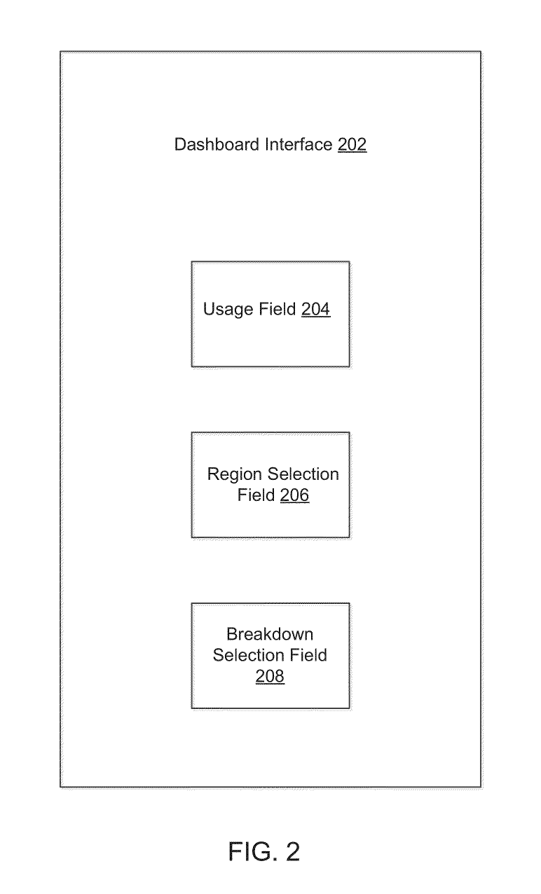

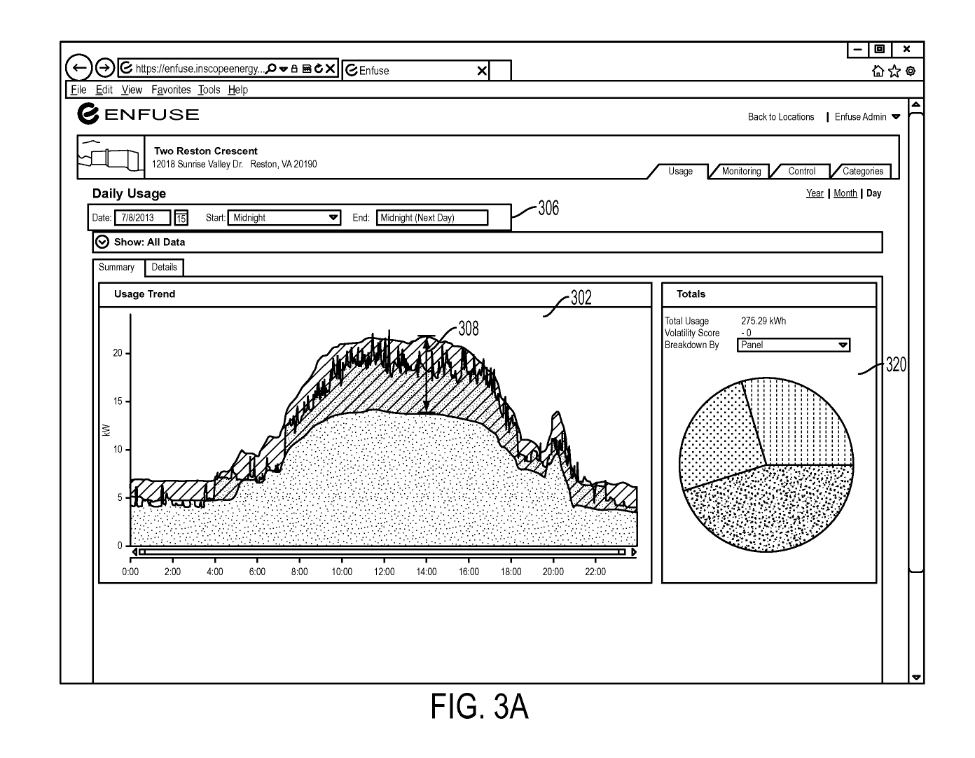

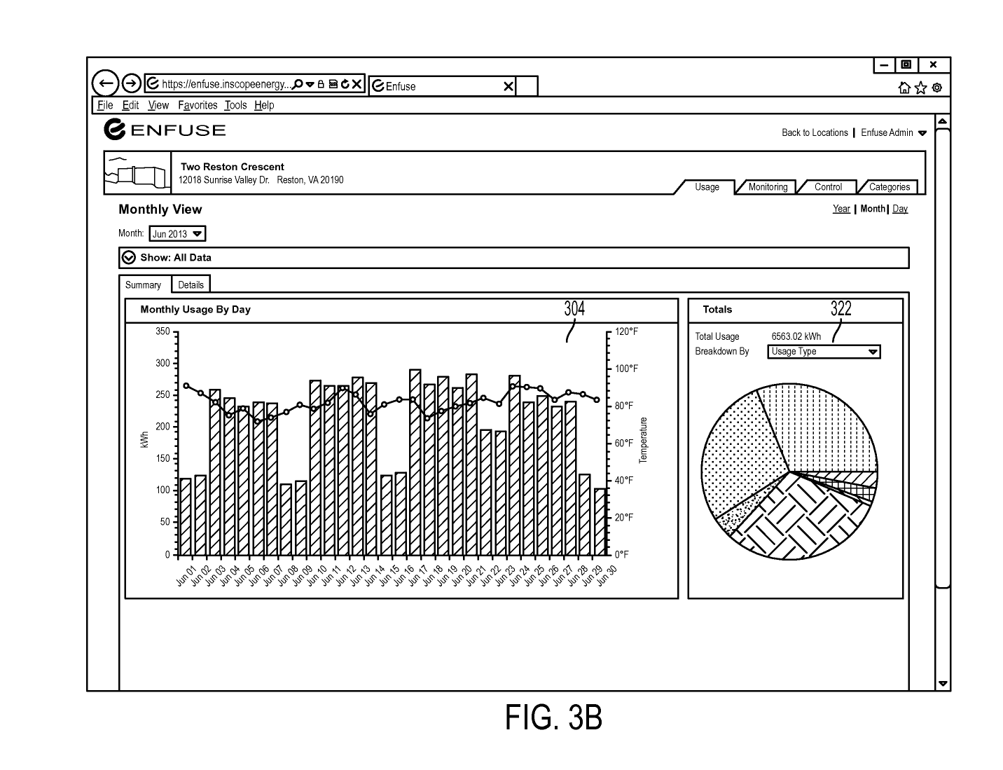

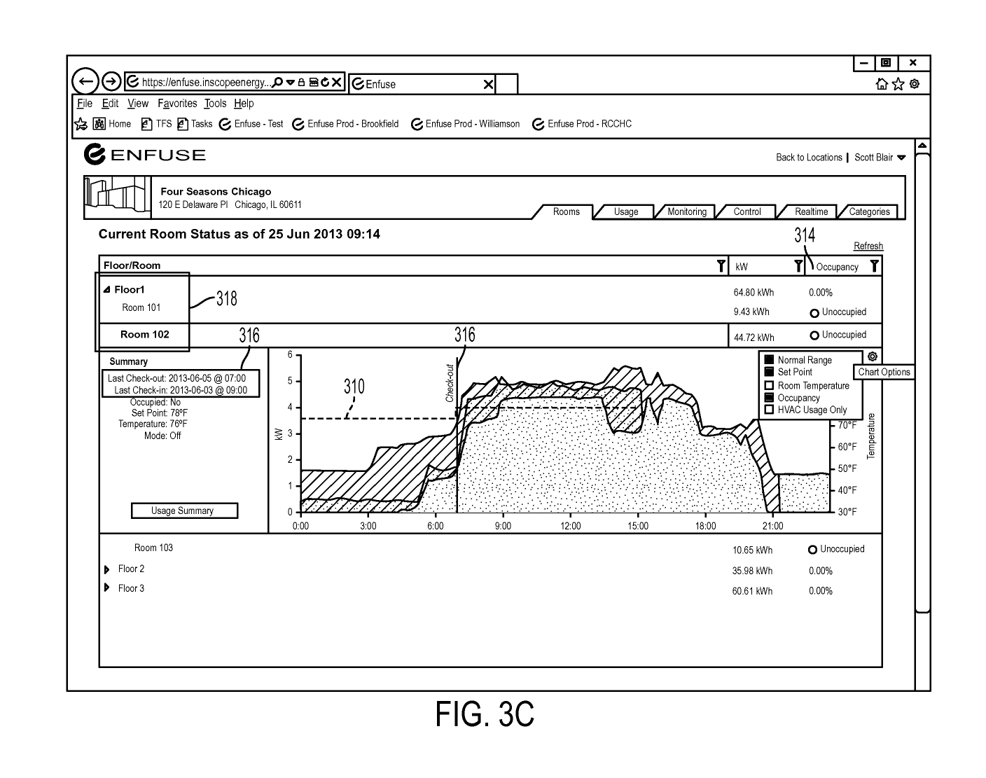

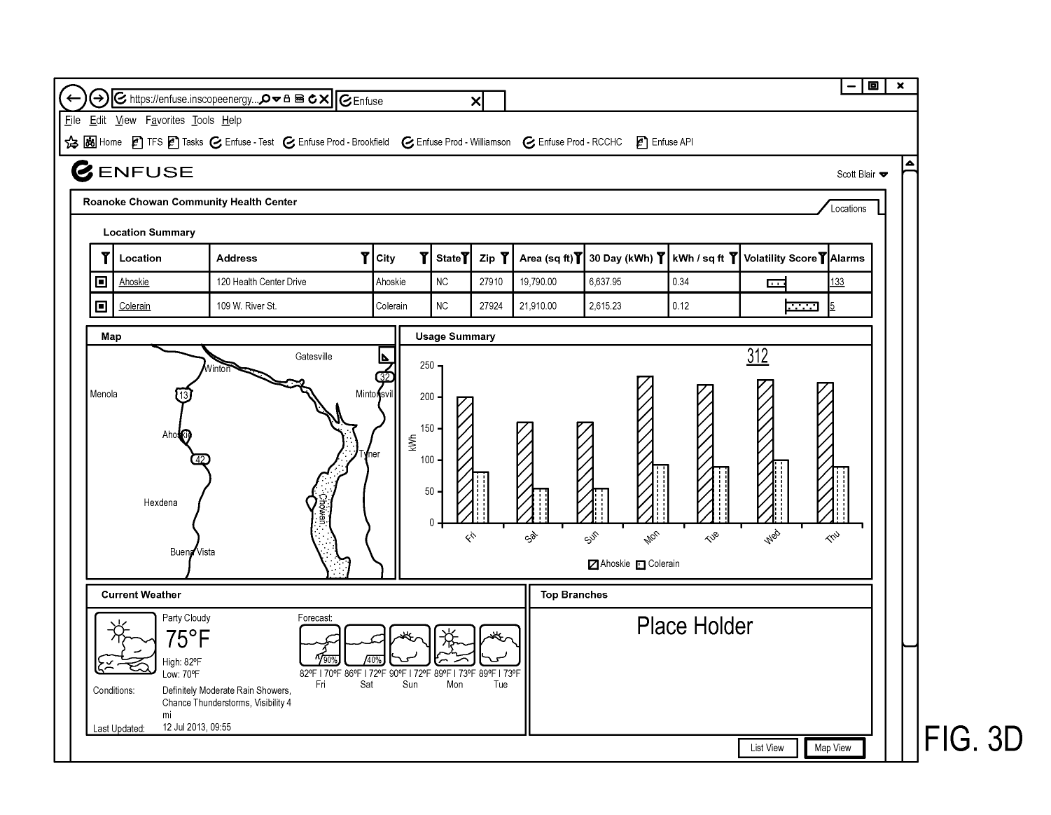

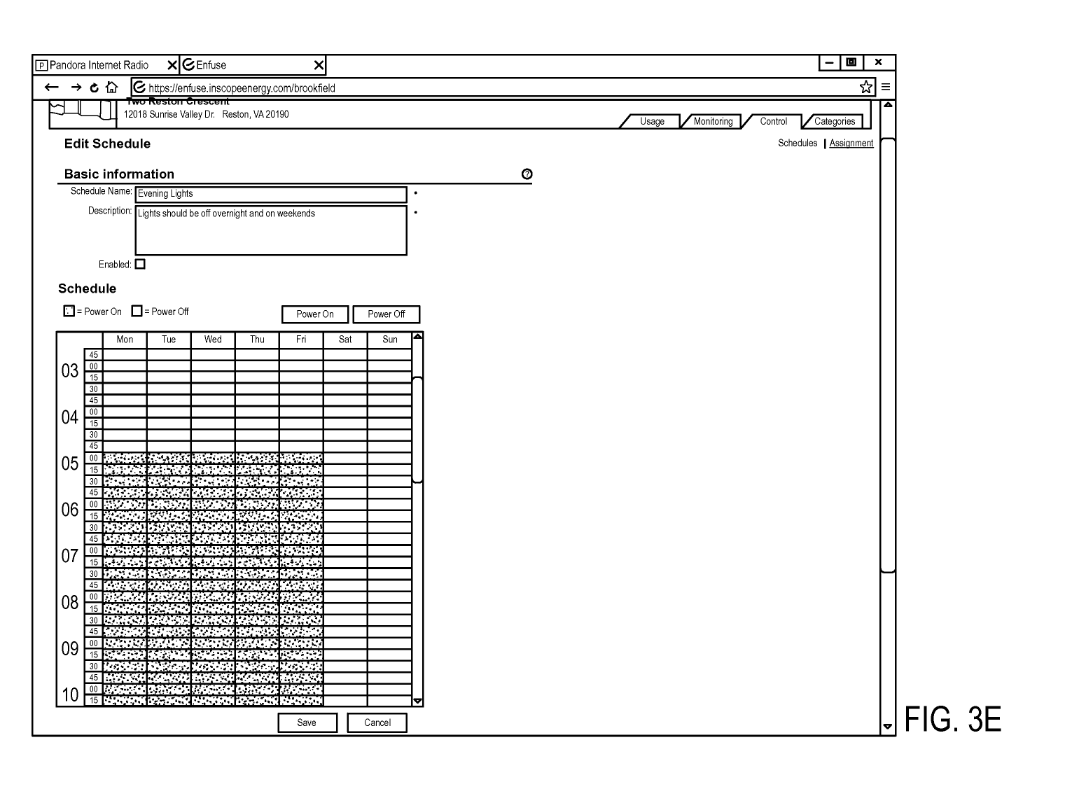

The dashboard interface module 110 may be configured to provide a dashboard interface for presentation to an administrator. FIG. 2 illustrates an exemplary dashboard interface 202, in accordance with one or more implementations. The dashboard interface 202 may be configured to facilitate interactions between system 100 and the administrator. The interactions may include providing information to and receiving information from the administrator. The dashboard interface 202 may include a graphical user interface. The dashboard interface 202 may include various text, graphics, plots, and/or other visual features to convey information to a user. FIGS. 3A-3E show screen shots of exemplary implementations of a dashboard interface.

The usage module 112 may be configured to provide a usage field (e.g., usage field 204 in FIG. 2) for presentation via the dashboard interface 202. The usage field 204 may convey information associated with usage of one or more resources of one or more structures. The information associated with the usage may include a usage plot showing a usage metric as a function of time (see, e.g., element 302 of FIG. 3A). In some implementations, the information associated with the usage may include a usage plot showing a usage metric and an ambient metric both as a function of time (see, e.g., element 304 of FIG. 3B). The ambient metric may be associated with ambient conditions inside or outside of the one or more structures. The usage plot may include a histogram of energy used per day as a function of time. The usage plot may be associated with a selectable time range (see, e.g., element 306 of FIG. 3A). The usage plot may include an expected usage range as a function of time (see, e.g., element 308 of FIG. 3A). The usage plot may convey a set point as a function of time (see, e.g., element 310 of FIG. 3C). The set point may be the temperature setting of an HVAC system within the one or more structures. The usage plot may convey a comparison between two or more regions of the one or more structures (see, e.g., element 312 of FIG. 3D).

The usage plot may include an indication of occupancy as a function of time (see, e.g., element 314 of FIG. 3C). The indication of occupancy may include a binary indication (e.g., occupied or unoccupied), an indication of a portion of total capacity (e.g., 75% occupied), an indication of absolute occupancy (e.g., five occupants), and/or other indications of occupancy. The usage plot may convey one or both of check in times or check out times (see, e.g., element 316 of FIG. 3C). A given check in time may be a time at which a structure occupant checked into or is scheduled to check into the one or more structures. A given check out time may be a time at which a structure occupant checked out of or is scheduled to check out of the one or more structures.

The region selection module 114 may be configured to provide a region selection field (see, e.g., region selection field 206 in FIG. 2) for presentation via the dashboard interface 202. The region selection field 206 may be configured to receive a region selection from the administrator. The region selection may indicate one or more spatial regions of one or more structures. A given region may include one or more of a group of structures, portions of structures in a group, a single structure, a portion of a structure (e.g., the west wing), a floor of a structure, a room of a structure, a hallway of a structure, a stairwell of a structure, and/or other spatial regions of one or more structures. The information conveyed by the usage field 206 may be determined based on a given region responsive to the given region being a selected region. Element 318 of FIG. 3C illustrates one exemplary implementation of region selection field 206.

The breakdown selection module 116 may be configured to provide a breakdown selection field (see, e.g., breakdown selection field 208 in FIG. 2) for presentation via the dashboard interface 202. The breakdown selection field 208 may be configured to receive a breakdown selection from the administrator. The breakdown selection may indicate one or more breakdowns of resource usage within the selected region. A given breakdown may include one or more of a breakdown of resource usage by electric distribution panel, a breakdown of resource usage by location, a breakdown of resource usage by usage type, a breakdown of resource usage by usage purpose, a breakdown of resource usage by occupied tenant, a breakdown of resource usage by security level, a breakdown of resource usage by a customized breakdown, and/or other breakdowns of resource usage. The information conveyed by the usage field 204 may be determined based on a given breakdown responsive to the given breakdown being a selected breakdown. Different breakdowns are illustrated in FIGS. 3A and 3B by elements 320 and 322, respectively. In element 320, the selected breakdown is “by panel” so that the pie chart in element 320 shows the proportionate usage per panel. By clicking a pie segment in element 320, usage information associated with a specific corresponding panel may be displayed in element 302. In element 322, the selected breakdown is “by usage type” so that the pie chart in element 322 shows the proportionate usage per usage type. By clicking a pie segment in element 322, usage information associated with a specific corresponding usage type may be displayed in element 304.

The policy module 118 may be configured to facilitate creation and/or enforcement of policies associated with usage of one or more resources of one or more structures. A given policy may specify how a given resource should be used for one or more breakdowns. For example, one policy may specify whether lights should be on or off, or be dimmed (1) during a specified period of time (2) for a specified region of one or more structures. As another example, one policy may specify heating or cooling parameters for a given tenant. Creating a given policy may include specifying one or more resources, and how those resources should be used for one or more breakdowns. Enforcing a given policy may include effectuating requirements set forth by that policy.

The policies may be tiered such that some policies encompass sub-policies. For example, a first policy may be associated with one or both of a first spatial region of the one or more structures or a first breakdown of resource usage, while a second policy may be associated with one or both of a subset of the first spatial region or a subset of the first breakdown. By way of non-limiting illustration, the first policy may be associated with an entire building whereas the second policy may be associated with a single floor within that building. In some implementations, the usage field may convey information associated one or more policies. FIG. 3E illustrates an exemplary policy creation field of dashboard interface 202. In the view shown in FIG. 3E, a policy name and textual description may be entered along with scheduling and power on/off information.

In some implementations, server(s) 102, client computing platform(s) 104, and/or external resources 120 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 120 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 120, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, and/or other computing platforms.

External resources 120 may include sources of information, external entities participating with system 100, and/or other resources. In some implementations, some or all of the functionality attributed herein to external resources 120 may be provided by resources included in system 100.

The server(s) 102 may include electronic storage 122, one or more processors 124, and/or other components. The server(s) 102 may include communication lines, or ports to enable the exchange of information with a network and/or other computing platforms. Illustration of server(s) 102 in FIG. 1 is not intended to be limiting. The server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 122 may comprise non-transitory storage media that electronically stores information. The electronic storage media of electronic storage 122 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor(s) 124, information received from server(s) 102, information received from client computing platform(s) 104, and/or other information that enables server(s) 102 to function as described herein.

The processor(s) 124 may be configured to provide information processing capabilities in server(s) 102. As such, processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 1 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. The processor(s) 124 may be configured to execute modules 106, 108, 110, 112, 114, 116, 118, and/or other modules. Processor(s) 124 may be configured to execute modules 106, 108, 110, 112, 114, 116, 118, and/or other modules by software; hardware; firmware; some combination of software, hardware, and/or firmware; and/or other mechanisms for configuring processing capabilities on processor(s) 124. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although 106, 108, 110, 112, 114, 116, and 118 are illustrated in FIG. 1 as being implemented within a single processing unit, in implementations in which processor(s) 124 includes multiple processing units, one or more of modules 106, 108, 110, 112, 114, 116, and/or 118 may be implemented remotely from the other modules. The description of the functionality provided by the different modules 106, 108, 110, 112, 114, 116, and/or 118 described herein is for illustrative purposes, and is not intended to be limiting, as any of modules 106, 108, 110, 112, 114, 116, and/or 118 may provide more or less functionality than is described. For example, one or more of modules 106, 108, 110, 112, 114, 116, and/or 118 may be eliminated, and some or all of its functionality may be provided by other ones of modules 106, 108, 110, 112, 114, 116, and/or 118. As another example, processor(s) 124 may be configured to execute one or more additional modules that may perform some or all of the functionality attributed below to one of modules 106, 108, 110, 112, 114, 116, and/or 118.

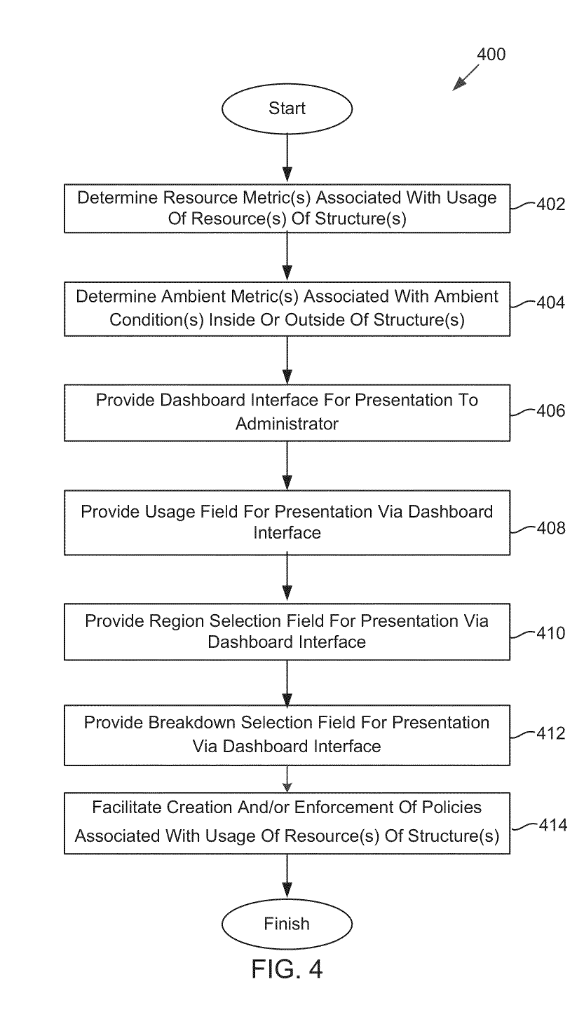

FIG. 4 illustrates a method 400 for monitoring and/or controlling resources of building structures, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, one or more resource metrics associated with usage of one or more resources of one or more structures may be determined. Operation 402 may be performed by one or more processors configured to execute a resource metric module that is the same as or similar to resource metric module 106, in accordance with one or more implementations.

At an operation 404, one or more ambient metrics associated with ambient conditions inside or outside of the one or more structures may be determined. Operation 404 may be performed by one or more processors configured to execute a ambient parameter module that is the same as or similar to ambient parameter module 108, in accordance with one or more implementations.

At an operation 406, a dashboard interface may be provided for presentation to an administrator. Operation 406 may be performed by one or more processors configured to execute a dashboard interface module that is the same as or similar to dashboard interface module 110, in accordance with one or more implementations.

At an operation 408, a usage field may be provided for presentation via the dashboard interface. Operation 408 may be performed by one or more processors configured to execute a usage module that is the same as or similar to usage module 112, in accordance with one or more implementations.

At an operation 410, a region selection field may be provided for presentation via the dashboard interface. Operation 410 may be performed by one or more processors configured to execute a region selection module that is the same as or similar to region selection module 114, in accordance with one or more implementations.

At an operation 412, a breakdown selection field may be provided for presentation via the dashboard interface. Operation 412 may be performed by one or more processors configured to execute a breakdown selection module that is the same as or similar to breakdown selection module 116, in accordance with one or more implementations.

At an operation 414, creation and/or enforcement of policies associated with usage of one or more resources of one or more structures may be facilitated. Operation 414 may be performed by one or more processors configured to execute a policy module that is the same as or similar to policy module 118, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for monitoring and/or controlling resources of building structures, the system comprising:
one or more processors configured to execute computer program modules, the computer program modules comprising:
a dashboard interface module configured to provide a dashboard interface for presentation to an administrator, the dashboard interface being configured to facilitate interactions between the system and the administrator, the interactions including providing information to and receiving information from the administrator;
a usage module configured to provide a usage field for presentation via the dashboard interface, the usage field conveying information associated with usage of one or more resources of one or more structures, wherein the information associated with the usage includes a usage plot showing a first usage metric as a function of time, the first usage metric being associated with at least one of the one or more resources; and
a breakdown selection module configured to provide a breakdown selection field for presentation via the dashboard interface, the breakdown selection field being configured to receive a breakdown selection from the administrator, the breakdown selection indicating one or more breakdowns of resource usage including a first breakdown, a given breakdown including one or more of a breakdown of resource usage by panel, a breakdown of resource usage by location, a breakdown of resource usage by usage type, or a breakdown of resource usage by security level;
wherein the information conveyed by the usage field is determined based on the first breakdown responsive to the first breakdown being a selected breakdown.

2. The system of claim 1, wherein the one or more resources include one or more of electricity, water, or gas.

3. The system of claim 1, wherein the usage plot includes a histogram of energy used per day as a function of time.

4. The system of claim 1, wherein the usage plot has a selectable time range.

5. The system of claim 1, wherein the usage plot includes an expected usage range as a function of time, the expected usage range being associated with the first usage metric.

6. The system of claim 1, wherein the usage plot includes an indication of occupancy as a function of time.

7. The system of claim 6, wherein the indication of occupancy is a binary indication, an indication of the actual occupancy, or an indication of a portion of total capacity.

8. The system of claim 1, wherein the usage plot conveys a set point as a function of time, the set point being the temperature setting of an HVAC system within the one or more structures.

9. The system of claim 1, wherein the usage plot conveys one or both of check in times or check out times, a given check in time being a time at which a structure occupant checked into or is scheduled to check into the one or more structures, a given check out time being a time at which a structure occupant checked out of or is scheduled to check out of the one or more structures.

10. The system of claim 1, wherein the usage plot conveys a comparison between two or more regions of the one or more structures.

11. The system of claim 1, wherein the computer program modules further comprise a region selection module configured to provide a region selection field for presentation via the dashboard interface, the region selection field being configured to receive a region selection from the administrator, the region selection indicating one or more spatial regions of one or more structures including a first region, a given region including one or more of a group of structures, portions of structures in a group, a single structure, a portion of a structure, a floor of a structure, a room of a structure, a hallway of a structure, or a stairwell of a structure, the information conveyed by the usage field being determined based on the first region responsive to the first region being a selected region.

12. The system of claim 1, wherein the computer program modules further comprise a policy module configured to facilitate creation and/or enforcement of policies associated with usage of one or more resources of one or more structures, the usage field conveying information associated with individual ones of the policies.

13. A system configured for monitoring and/or controlling resources of building structures, the system comprising:
one or more processors configured to execute computer program modules, the computer program modules comprising:
a dashboard interface module configured to provide a dashboard interface for presentation to an administrator, the dashboard interface being configured to facilitate interactions between the system and the administrator, the interactions including providing information to and receiving information from the administrator; and
a usage module configured to provide a usage field for presentation via the dashboard interface, the usage field conveying information associated with usage of one or more resources of one or more structures, wherein the information associated with the usage includes a usage plot showing a first usage metric and a first ambient metric both as a function of time, the first usage metric being associated with at least one of the one or more resources, the first ambient metric being associated with an ambient condition inside or outside of the one or more structures.

14. The system of claim 13, wherein the one or more resources include one or more of electricity, water, or gas.

15. The system of claim 13, wherein the ambient conditions inside the one or more structures include a temperature inside the one or more structures, a humidity inside the one or more structures, or an air flow inside the one or more structures.

16. The system of claim 13, wherein the ambient conditions outside the one or more structures include a temperature outside the one or more structures but nearby, a humidity outside the one or more structures but nearby, or an air flow outside the one or more structures but nearby.

17. The system of claim 13, wherein the computer program modules further comprise a region selection module configured to provide a region selection field for presentation via the dashboard interface, the region selection field being configured to receive a region selection from the administrator, the region selection indicating one or more spatial regions of one or more structures including a first region, a given region including one or more of a group of structures, portions of structures in a group, a single structure, a portion of a structure, a floor of a structure, a room of a structure, a hallway of a structure, or a stairwell of a structure, the information conveyed by the usage field being determined based on the first region responsive to the first region being a selected region.

18. The system of claim 13, wherein the computer program modules further comprise a breakdown selection module configured to provide a breakdown selection field for presentation via the dashboard interface, the breakdown selection field being configured to receive a breakdown selection from the administrator, the breakdown selection indicating one or more breakdowns of resource usage including a first breakdown, a given breakdown including one or more of a breakdown of resource usage by panel, a breakdown of resource usage by location, a breakdown of resource usage by usage type, or a breakdown of resource usage by security level, the information conveyed by the usage field being determined based on the first breakdown responsive to the first breakdown being a selected breakdown.

19. The system of claim 13, wherein the computer program modules further comprise a policy module configured to facilitate creation and/or enforcement of policies associated with usage of one or more resources of one or more structures, the usage field conveying information associated with individual ones of the policies.

20. A system configured for monitoring and/or controlling resources of building structures, the system comprising:
one or more processors configured to execute computer program modules, the computer program modules comprising:
a dashboard interface module configured to provide a dashboard interface for presentation to an administrator, the dashboard interface being configured to facilitate interactions between the system and the administrator, the interactions including providing information to and receiving information from the administrator;
a usage module configured to provide a usage field for presentation via the dashboard interface, the usage field conveying information associated with usage of one or more resources of one or more structures, wherein the information associated with the usage includes a usage plot showing a first usage metric as a function of time, the first usage metric being associated with at least one of the one or more resources; and
a policy module configured to facilitate policies associated with usage of one or more resources of one or more structures, the policies including a first policy and a second policy, the first policy being associated with one or both of a first spatial region of the one or more structures or a first breakdown of resource usage, the second policy being associated with one or both of a subset of the first spatial region or a subset of the first breakdown.

21. The system of claim 20, wherein the one or more resources include one or more of electricity, water, or gas.

22. The system of claim 20, wherein the usage field conveys information associated with one or both of the first policy or the second policy.

23. The system of claim 20, wherein the computer program modules further comprise a region selection module configured to provide a region selection field for presentation via the dashboard interface, the region selection field being configured to receive a region selection from the administrator, the region selection indicating one or more spatial regions of one or more structures including a first region, a given region including one or more of a group of structures, portions of structures in a group, a single structure, a portion of a structure, a floor of a structure, a room of a structure, a hallway of a structure, or a stairwell of a structure, the information conveyed by the usage field being determined based on the first region responsive to the first region being a selected region.

24. The system of claim 20, wherein the computer program modules further comprise a breakdown selection module configured to provide a breakdown selection field for presentation via the dashboard interface, the breakdown selection field being configured to receive a breakdown selection from the administrator, the breakdown selection indicating one or more breakdowns of resource usage including a first breakdown, a given breakdown including one or more of a breakdown of resource usage by panel, a breakdown of resource usage by location, a breakdown of resource usage by usage type, or a breakdown of resource usage by security level, the information conveyed by the usage field being determined based on the first breakdown responsive to the first breakdown being a selected breakdown.
